(19) United States
(12) Patent Application Publication
(10) Pub. No.: US 2025/0288018 A1
(43) Pub. Date: Sep. 18, 2025

(54) Aerosol Generating Devices

(71) Applicant: JT International SA, Geneva (CH)

(72) Inventors: Tilen Ceglar, Vienna (AT); Jaakko McEvoy, Vienna (AT)

(73) Assignee: JT International SA, Geneva (CH)

(21) Appl. No.: 18/860,356

(22) PCT Filed: Apr. 24, 2023
(86) PCT No.: PCT/EP2023/060573

§ 371 Date: Oct. 25, 2024

(30) Foreign Application Priority Data
Apr. 27, 2022 (EP) 22170200.4

(51) Int. Cl. A24F 40/57; A24F 40/20; A24F 40/465; A24F 40/51; A24F 40/53; H05B 6/10

(52) U.S. Cl. CPC A24F 40/57; A24F 40/20; A24F 40/465; A24F 40/51; A24F 40/53; H05B 6/108

(57) ABSTRACT

A method of operating an aerosol generating device, where the device includes a heating chamber configured to receive an aerosol generating article and an induction heater comprising an induction coil operable to supply an alternating magnetic field to the heating chamber so as to induce eddy currents within a susceptor located in the heating chamber, wherein the method incudes: (a) applying an alternating current at an applied frequency to the induction coil, (b) measuring a characteristic indicative of an impedance of the induction coil while a susceptor located in the heating chamber is moved through a pre-defined motion, (c) determining a minimum reference impedance of the induction coil and a maximum reference impedance of the induction coil using the measured characteristic, (d) measuring a characteristic indicative of an operation impedance of the induction coil, and (e) setting a power delivered by the induction coil using the operation impedance.

### TECHNICAL FIELD

The present disclosure relates generally to an aerosol generating device for heating an aerosol generating substrate to generate an aerosol for inhalation by a user of the aerosol generating device. The present disclosure is particularly applicable to a portable (hand-held) aerosol generating device. Such devices heat, rather than burn, an aerosol generating substrate, e.g., tobacco or other suitable materials, by conduction, convection, and/or radiation to generate an aerosol for inhalation by a user.

### TECHNICAL BACKGROUND

The popularity and use of reduced-risk or modified-risk devices (also known as aerosol generating devices or vapour generating devices) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Currently available aerosol generating devices can use one of a number of different approaches to provide heat to the aerosol generating substrate. One such approach is to employ an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by conduction, to the aerosol generating substrate and an aerosol is generated as the aerosol generating substrate is heated. The susceptor may surround the aerosol generating substrate and transfer heat to an outer surface of the aerosol generating substrate. Alternatively, the susceptor may be embedded in the aerosol generating substrate.

In most such aerosol generating devices, the heater operates in a predetermined manner when commanded to start, for example in response to the user pushing a start button or in response to the device determining by means of an airflow sensor that the user has inhaled a puff through the device. Some aerosol generating devices allow a user to select between different power levels or heating profiles according to personal preference. Such a selection is typically made via a user interface on the aerosol generating device or a connected device.

### SUMMARY OF THE INVENTION

According to a first aspect of the invention there is provided a method of operating an aerosol generating device that comprises:
a heating chamber configured to receive an aerosol generating article:
an induction heater comprising an induction coil operable to supply an alternating magnetic field to the heating chamber so as to induce eddy currents within a susceptor located in the heating chamber;
wherein the method comprises:
(a) applying an alternating current at an applied frequency to the induction coil:
(b) measuring a characteristic indicative of an impedance of the induction coil while a susceptor located in the heating chamber is moved through a pre-defined motion:
(c) determining a minimum reference impedance of the induction coil and a maximum reference impedance of the induction coil using the measured characteristic, the minimum reference impedance being associated with a first position within the pre-defined motion and the maximum impedance being associated with a second position within the pre-defined motion:
(d) measuring a characteristic indicative of an operation impedance of the induction coil while the susceptor located in the heating chamber is maintained at a user-selected position within the pre-defined motion; and
(e) setting a power delivered by the induction coil using the operation impedance.

The maximum reference impedance corresponds to a first position of the susceptor selected from the range of possible positions permitted within the pre-defined motion. Similarly, the minimum reference impedance corresponds to a second position of the susceptor within the pre-defined motion. In use, a user of the device may choose whether to locate the susceptor at the first position or the second position, or at a third position that is different to both the first and second positions. In accordance with the method set out above, the controller uses the measured operation impedance, as determined by the position of the aerosol generating article selected by the user, to set the power delivered by the induction coil. Thus, by moving an aerosol generating article within the heating chamber to a user-selected position, a user is able to easily and intuitively set the power delivered by the induction coil.

The pre-defined motion refers to a motion of the susceptor that may be actuated by a user in a manner which is consistently repeatable. The pre-defined motion may be a rotation, for example a rotation through 360 degrees or more. A full rotation of the susceptor within the heating chamber guarantees measurement of a full range of impedance values for the coil. Further, rotation is an intuitive movement for the user that is easy to repeat consistently.

The susceptor may be asymmetric under the pre-defined motion. That is, the susceptor may have a shape that is asymmetric under the pre-defined motion. Such asymmetry may increase the variation in the measured impedance. For example, the susceptor may be helical, and may be selected to have the same pitch as the inductance coil. Again, this may increase the variation in the measured impedance. (It is noted that a helix is asymmetric under rotation.)

The applied frequency may be greater than 1 MHz, for example in the range 1-15 MHZ, 1-12 MHz, or 1-10 MHz.

The method may further comprise providing an indication to a user indicative of the power set in step (e). The indication may be provided via a user interface, such as one or more LEDs, or a screen of the aerosol generating device or a connected device.

Setting a power delivered by the induction coil using the operation impedance may comprise determining a scaling factor by comparing the operation impedance with one or both of the maximum and minimum reference impedances: and scaling a power delivered by the induction coil using the determined scaling factor.

The method may further comprise detecting insertion of a susceptor into the heating chamber: detecting a movement of the susceptor through the pre-defined motion; and automatically activating the method of steps (b)-(e).

The characteristic indicative of impedance may be measured continuously in step (b). The measurement may be made by comparing the impedance of the coil to a known reference impedance.

According to a second aspect of the invention there is provided an aerosol generating device comprising:
a heating chamber configured to receive an aerosol generating article:
an induction heater comprising an induction coil operable to supply an alternating magnetic field to the heating chamber so as to induce eddy currents within a susceptor located in the heating chamber; and
a controller configured to:
   (a) apply an alternating current at an applied frequency to the induction coil:
   (b) measure a characteristic indicative of an impedance of the induction coil while a susceptor located in the heating chamber is moved through a pre-defined motion:
   (c) determine a minimum reference impedance of the induction coil and a maximum reference impedance of the induction coil using the measured characteristic, the minimum reference impedance being associated with a first position within the pre-defined motion and the maximum impedance being associated with a second position within the pre-defined motion:
   (d) measure a characteristic indicative of an operation impedance of the induction coil while the susceptor located in the heating chamber is maintained at a user-selected position within the pre-defined motion; and
   (e) set a power delivered by the induction coil using the operation impedance.

The aerosol generating device of the second aspect of the invention may further comprise any of the optional features of the first aspect of the invention.

According to a third aspect of the invention there is provided an aerosol generating system comprising an aerosol generating device in accordance with the second aspect of the invention; and an aerosol generating article comprising an asymmetric susceptor.

The induction coil may be a helical coil having a coil pitch, and the asymmetric susceptor may comprise a helical susceptor having a susceptor pitch, wherein the susceptor pitch is substantially the same as the coil pitch.

The asymmetric susceptor may comprise a first susceptor and a secondary susceptor, the secondary susceptor being smaller than the first susceptor such that a heating effect provided by the secondary susceptor is negligible when compared with a heating effect provided by the primary susceptor.

Features of the above aspects of the invention may be combined together, as well as with features selected from the description, unless expressly stated otherwise.

### BRIEF DESCRIPTION OF THE DRAWINGS

The present invention will now be described in more detail, by way of example only, with reference to the accompanying drawings, in which:

FIG. 1 is a diagrammatic cross-sectional view of an aerosol generating system comprising an aerosol generating device and an aerosol generating article positioned in a heating chamber of the aerosol generating device:

FIG. 2 is a schematic illustration of an induction coil, a helical susceptor and a heating controller in isolation from an aerosol generating device:

FIG. 3 shows cross sectional view of a helical susceptor within an induction coil when (A) in phase (0 degrees), (B) fully out of phase (180 degrees), and (C) partly out of phase (90 degrees):

FIG. 4 is schematic illustration depicting exemplary lines of magnetic flux around an induction coil:

FIG. 5 illustrates variations in magnetic field density when a helical susceptor is (A) in phase with an induction coil, and (B) 180 degrees out of phase with the same induction coil:

FIG. 6 illustrates a method of calibrating an aerosol generating device:

FIG. 7 shows variation in measured impedance during a calibration method:

FIG. 8 schematically shows an alternative susceptor:

FIG. 9 shows a further alternative susceptor: and

FIG. 10 is a flow chart setting out a method of operating an aerosol generating device.

### DETAILED DESCRIPTION

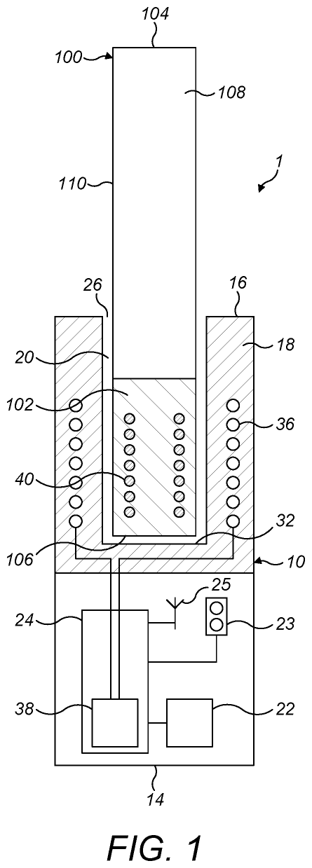

Referring initially to FIG. 1, there is shown diagrammatically an example of an aerosol generating system 1. The aerosol generating system 1 comprises an aerosol generating device 10 and an aerosol generating article 100 for use with the device 10. The aerosol generating device 10 can have any shape that is sized to fit the components described in the various embodiments set out herein and to be comfortably held by a user unaided, in a single hand.

A first end 14 of the aerosol generating device 10, shown towards the bottom of FIG. 1, is described for convenience as a distal, bottom, base or lower end of the aerosol generating device 10. A second end 16 of the aerosol generating device 10, shown towards the top of FIG. 1, is described as a proximal, top or upper end of the aerosol generating device 10. During use, the user typically orients the aerosol generating device 10 with the first end 14 downwards and/or in a distal position with respect to the user's mouth and the second end 16 upwards and/or in a proximal position with respect to the user's mouth.

The aerosol generating device 10 comprises a heating chamber 18. The heating chamber 18 defines an interior volume in the form of a cavity 20 having a substantially cylindrical cross-section for receiving an aerosol generating article 100. The cavity 20 of the heating chamber 18 is open towards the second end 16 of the aerosol generating device 10. The heating chamber 18 comprises an induction heater, such as an induction coil 36, for heating an aerosol generating article 100 that is received in the cavity 20. The heating chamber 18 has a longitudinal axis defining a longitudinal direction and is formed of a heat-resistant plastics material, such as polyether ether ketone (PEEK).

The aerosol generating device 10 further comprises a power source 22, for example one or more batteries which may be rechargeable, and a controller 24, which couples the power source to the heater. The controller 24 may also be connected to a user interface 23 comprising inputs such as a power button for receiving commands from a user and/or outputs such as indicator lights, a display screen or an audible or vibratory alarm for providing information to the user. The controller may also be interfaced with an antenna 25 for wireless communication with a remote device such as the user's smartphone, which can be used for input and output, as well as for relaying data between the aerosol generating device 10 and its manufacturer.

The heating chamber 18, and specifically the cavity 20, is arranged to receive a correspondingly shaped generally cylindrical or rod-shaped aerosol generating article 100. Typically, the aerosol generating article 100 comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The distal end 106 is inserted into the heating chamber 18 of the aerosol generating device 10 so that at least the aerosol generating substrate 102 is contained within the heating chamber 18. The aerosol generating article 100 further comprises a mouthpiece segment 108 positioned downstream of the aerosol generating substrate 102. At least part of the mouthpiece segment 108 projects from the heating chamber 18 so that the proximal end 104 of the aerosol generating article 100 is accessible to be taken into the mouth of a user. When the aerosol generating device 10 applies heat to the aerosol generating article 100, heated vapour is emitted from the aerosol generating substrate 102. As inhalation by the user draws air towards the proximal end 104 of the aerosol generating article 100, the vapour cools and condenses as it passes through the mouthpiece segment 108 to form an aerosol with characteristics suitable for inhalation. The mouthpiece segment 108 may further comprise a filter (not shown) to remove particles or drops above a certain size from the airstream.

The aerosol generating substrate 102 and the mouthpiece segment 108 are arranged in coaxial alignment inside a wrapper 110 (e.g., a paper wrapper) to hold the components in position to form the rod-shaped aerosol generating article 100. The wrapper 110 typically does not cover the ends 104,106 of the aerosol generating article 100 in order that air can flow through the aerosol generating article 100 from the distal end 106 to the proximal end 104.

In the illustrated embodiments of the invention, the heating chamber 18 comprises an open end 26 and a closed base 32. That is, the heating chamber 18 is cup shaped. This can ensure that air drawn from the open end 26 is guided through the aerosol generating substrate 102.

As noted above, in the example shown in FIG. 1 an induction heater is provided for heating an aerosol generating article 100 received in the cavity 20. An induction coil 36, specifically a helical induction coil, surrounds the cavity 20 and is spaced from it. Means for mounting the induction coil 36 are typically mounted on an outer wall of the heating chamber 18. A heating controller 38 controls the supply of electrical power from the power source 22 to the induction coil 36. The heating controller 38 includes, among other electronic components, an inverter which is arranged to convert a direct current from the power source 22 into an alternating high-frequency current for the induction coil 36.

A susceptor 40 is located inside the cavity 20 of the heating chamber 18. Typically, the susceptor 40 comprises one or more elements disposed in contact with or in close proximity with the aerosol generating substrate 102 of an aerosol generating article 100 that is received in the cavity 20. When the heating controller 38 supplies power to the heating coil 36 at a suitable frequency, it generates alternating magnetic fields, which induce currents to flow in the susceptor 40. The material and structure of the susceptor 40 are chosen such that eddy currents induced in the susceptor 40 cause power to be dissipated as heat. The heat is transferred by conduction, convection and/or radiation to the substrate 102 of the aerosol generating article 100 and causes volatile substances in the substrate 102 to vaporize. The volatile substances are entrained in the flow of air drawn through the aerosol generating article to form an aerosol that can be inhaled by the user, as previously described.

The susceptor 40 may be formed of any suitable material in which eddy currents are generated under the influence of an alternating magnetic field to produce a heating effect sufficient to generate an aerosol from the aerosol forming substrate, such as a ferromagnetic metal. Non-limiting example materials include carbon steel, stainless steel, and aluminium.

In the present example the susceptor 40 is shown included within the aerosol generating article 100, so as to be in physical contact with the aerosol generating substrate 102.

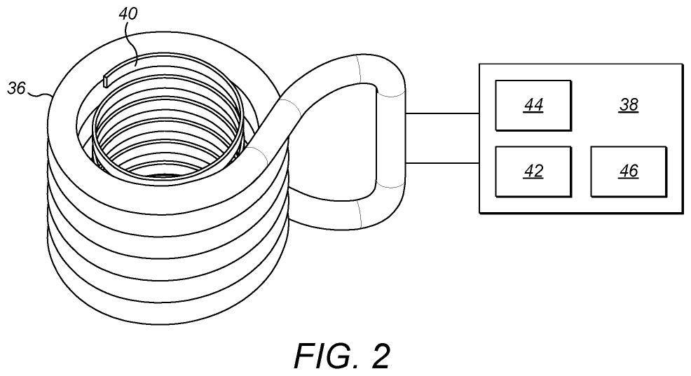

As shown in FIG. 2, the heating controller 38 includes a power control sub-system 42 and a measurement sub-system 44. The heating controller further includes a memory 46. The power control sub-system 42 is operable to control the activation of the induction coil in order to deliver an alternating magnetic field to the susceptor. The measurement sub-system 44 is operable to measure an impedance (or a characteristic representative of impedance) of the induction coil whilst the coil is energised. Measurements made by the measurement sub-system 44 and/or power delivery control instruction may be stored in the memory 46.

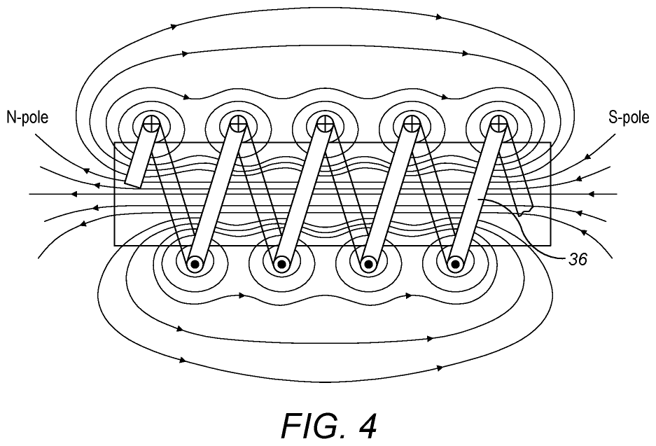

The applicant has recognised that the impedance of an induction coil is influenced not only by the coil itself, but also by a susceptor's geometrical properties when the susceptor is placed inside an electromagnetic (EM) field generated by the coil. Generally, the magnetic flux density around an induction coil is non-uniform, as illustrated schematically in FIG. 4. This means that the placement of a susceptor relative the EM field has different coupling effects depending on where the susceptor is located within the EM field. These coupling effects include generation of eddy currents in the susceptor which (in addition to causing heating of the susceptor, as discussed above) also induce their own EM field and influence the impedance of the inductance coil in the device. Thus, as a susceptor is moved within an EM field generated by an induction coil, the coupling effects between the susceptor and the coil change. This, in turn, changes how the eddy currents affect the impedance of the induction coil. This change in impedance is measurable, for example by comparison of the detected coil impedance with a known reference impedance.

Referring now to FIG. 10, a method of operating an aerosol generating device 10 is described. In step 1010, the controller 24 (and more specifically, the power control sub-system 42 of the heating controller 38) is operable to apply an alternating current at an applied frequency to the induction coil 36 of the aerosol generating device. In step 1012, the controller 24 (and more specifically, the measurement sub-system 44 of the heating controller 38) is operable to measure a characteristic indicative of an impedance of the induction coil 36 while a susceptor 40 located in the heating chamber 18 is moved through a pre-defined motion. In step 1014, a minimum reference impedance of the induction coil 36 and a maximum reference impedance of the induction coil 36 are determined using the measured impedance (or measured characteristic, as the case may be). Steps 1012 and 1014 may be thought of as a calibration stage, during which the relative change in impedance of the induction coil is measured as the susceptor is moved through the pre-defined motion. Some or all of the measured data, and in particular the determined maximum and minimum reference impedance values, may be stored in the memory 46.

In step 1016, the controller 24 (and more specifically, the measurement sub-system 44 of the heating controller 38) measures an operation impedance of the induction coil 36 (or a characteristic indicative of said operation impedance, as the case may be). Finally, in step 1018, the controller 24 (and more specifically, the power control sub-system 42 of the heating controller 38) sets a power delivered by the induction coil 36 using the measured operation impedance.

The controller 24 thus takes advantage of the changing coupling effects discussed above to set the power delivered by the coil in accordance with a measured an operation impedance of the susceptor. The operation impedance refers to the impedance when the susceptor is at rest, in a position in which the user intends to operate the aerosol generating device. The operation impedance is compared with the stored impedance information measured as the susceptor was moved through the pre-defined motion, such that a scaling factor may be determined which represents the operation impedance as a percentage of the maximum measured impedance. This scaling factor is used to set the power delivered by the induction heater.

Put another way, the controller uses the measured impedance to determine a first position of the susceptor within the pre-defined motion that equates to the maximum reference impedance, and to determine a second position of the susceptor within the pre-defined motion that equates to the minimum reference impedance. The first position may equate to power delivery at, for example, 100%, whilst the second position may equate to a reduced power delivery, for example at 50%, or 60% or 70%. In use, a user of the device has the option to locate the susceptor at a position of their choosing. This could be the first position or the second position, or at a third position that is different to both the first and second positions. In the third position power may be delivered at a scaled percentage between 100% and the minimum (e.g. 60%), depending on the scaling factor determined by comparing the operation impedance at the third position with the maximum measured impedance. The controller 24 measures the operation impedance to determine the position selected by the user, and sets the power according to that selected position.

The user interface 23 (if present) may be operable to indicate to a user what power profile has been selected. For instance, one or more LED indicators may increase in brightness, or may be selectively illuminated, as the power delivery is increased. This allows the user to understand whether the aerosol generating article is located at the first (maximum) position, at the second (minimum) position, or at an intermediate third position.

It should be noted that the changing coupling effect that occurs during motion of the susceptor is not in itself significant enough to inherently have a change in the temperature achieved by the susceptor. This must be done separately by the firmware of the power control sub-system 42 in dependence on the measured operation impedance relative to the maximum/minimum reference impedances.

The measured impedance change discussed above may be greater when the susceptor 40 is asymmetric (e.g. asymmetric in shape under the pre-defined motion). Thus providing an asymmetric susceptor may facilitate and/or simplify measurement in the above-described power control method.

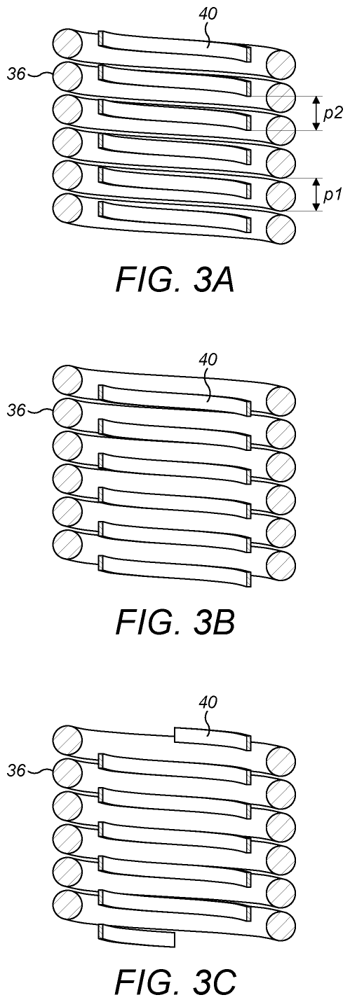

FIGS. 2 and 3 show an example of an induction coil 36 and susceptor 40 in more detail. The induction coil 36 is a helical coil having a coil pitch p1 (see FIG. 3). The susceptor 40 is an asymmetric susceptor. Specifically, the susceptor 40 is a helical susceptor having a susceptor pitch p2. It will be understood that the pitch of a helix is the height of one complete helix turn, measured parallel to the longitudinal axis of the helix. In the example shown, p1 is approximately equal to p2; that is, the induction coil 36 and susceptor 40 have the same (or approximately the same) pitch.

The induction coil further has a coil diameter (being the diameter of the coil as a whole) and a wire diameter (being the diameter of the wire forming the windings of the coil. Similarly, the susceptor 40 has a susceptor diameter, which is less than the coil diameter such that the susceptor 40, when incorporated into an aerosol generating article 100, may fit comfortably within the induction coil 36 that surrounds the heating chamber 20.

The susceptor 40 is, in the present example, a metal tape. The height of the metal tape may be similar to, or less than, the wire diameter of the induction coil 36. Such a helix or spiral susceptor shape approximates a thin-walled cylinder.

To construct an aerosol generating article 100 incorporating such a susceptor, a flat and thin metal tape, e.g. carbon steel, stainless steel, aluminium, etc., may be wound around reconstructed tobacco strips, then enclosed by another layer of tobacco and finally wrapping paper. Thereby, the susceptor is circumferentially placed between two regions of tobacco with approximately equivalent thermal mass. Wrapping the susceptor flat wire into a helix or spiral shapes also ensures good thermal contact. This ensures more uniform heating of the tobacco which can reduce the peak temperatures on the susceptor and improve energy efficiency and mitigate the risk of local pyrolysis.

In the example shown in FIG. 3, the inductance coil has the following properties:
Copper coil: 6 windings
   8 mm coil diameter
   1 mm wire diameter
Relative permeability=1
Relative permittivity=1
Electrical conductivity=5.998e7 S/m

In the example shown in FIG. 3, the susceptor has the following properties:
Aluminium susceptor: 6 windings
   4 mm susceptor diameter
   0.2×0.8 mm cross section
Relative permeability=1
Relative permittivity=1
Electrical conductivity=3.77e7 S/m

It will be understood that the above numerical values are exemplary only, and that other values are possible.

The non-uniform nature of the magnetic flux density generated by an induction coil permits an asymmetric susceptor 40, for example of the type shown in FIGS. 2 and 3, to be used to identify the orientation of the susceptor relative to the coil.

FIG. 3 demonstrates how a phase angle between an induction coil 36 and a helical susceptor 40 located within the induction coil varies as the helical susceptor is rotated relative to the induction coil. The phase angle ranges from 0 degrees (in-phase), as shown in picture A, to 180 degrees (out-of-phase) as shown in picture B. Picture C shown an intermediate position wherein the phase angle is 90 degrees.

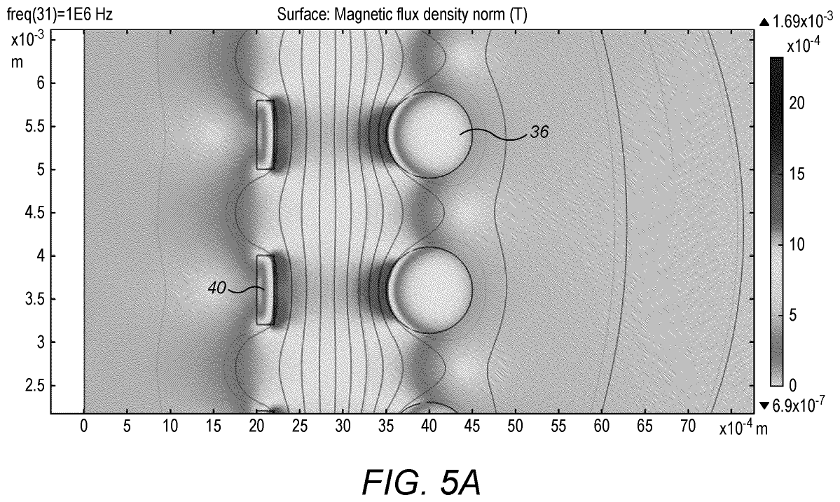

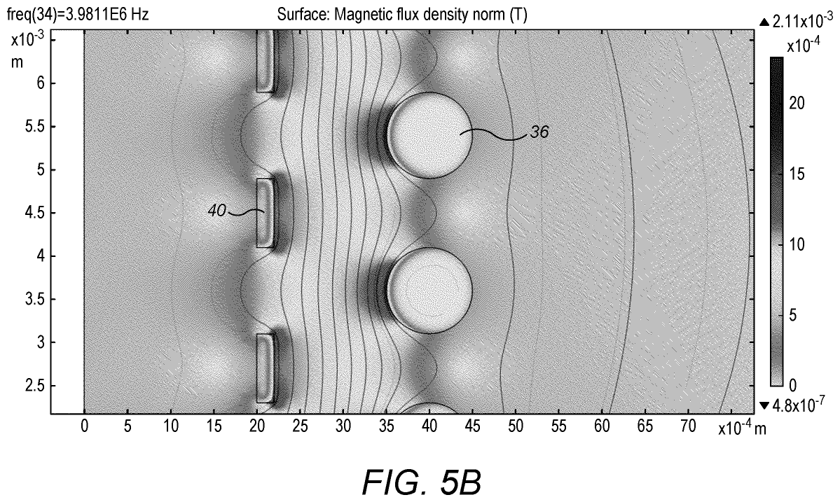

Due to the non-uniform magnetic flux density, the coupling effect between the coil and the susceptor changes as the phase angle changes. Picture A of FIG. 5 illustrates the variation in magnetic flux density between windings of an induction coil 36 and a helical susceptor located within the coil when the coil and susceptor are in phase. Conversely, picture B of FIG. 5 illustrates the variation in magnetic flux density between windings of the induction coil 36 and the helical susceptor when the coil and susceptor are 180 degrees out of phase.

As shown in FIGS. 3 and 5, a susceptor which is made out of thin metal tape wound into a helix shape with the same pitch as the induction coil can be oriented at areas with higher or lower magnetic flux simply by rotating the susceptor within the coil. During rotation of the susceptor, the device measures the impedance of the induction coil and records the minimum and maximum impedance values, which are stored in memory 46. A similar phase change effect may be produced by moving the susceptor longitudinally within the induction coil. When the susceptor is at rest, the final position of the susceptor is determined and is used to set the power profile of the device.

The change in coupling effect can be measured via the change in the impedance of the coil, as discussed above. For example, one method of measuring the impedance of a coil is to compare the coil impedance with a known impedance in a circuit. Thereby, the unknown impedance of the coil can be determined. Coil impedance is a function of the AC frequency that is applied to the coil. A sizable relative change can be measured if the applied frequency is 1 MHz or greater, for example in the range 1-10 MHz.

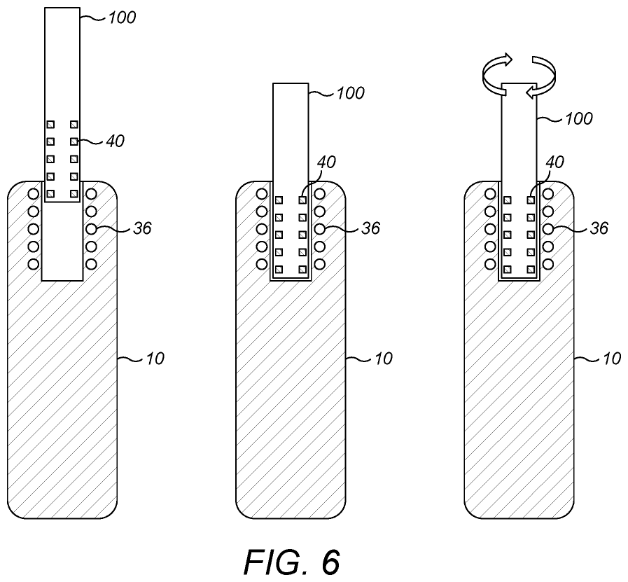

It will be appreciated that the susceptor 40 may be rotated relative to the induction coil 36 by rotating an aerosol generating article 100 within which the susceptor is comprised, as shown in FIG. 6. In use, a user inserts an aerosol generating article 100 into the aerosol generating device 10. The aerosol generating article includes an asymmetric susceptor of the type discussed above. The device 10 recognises the presence of the susceptor via the coupling effect between the susceptor and the induction coil 36 of the device, and so recognises that an aerosol generating article 100 has been inserted.

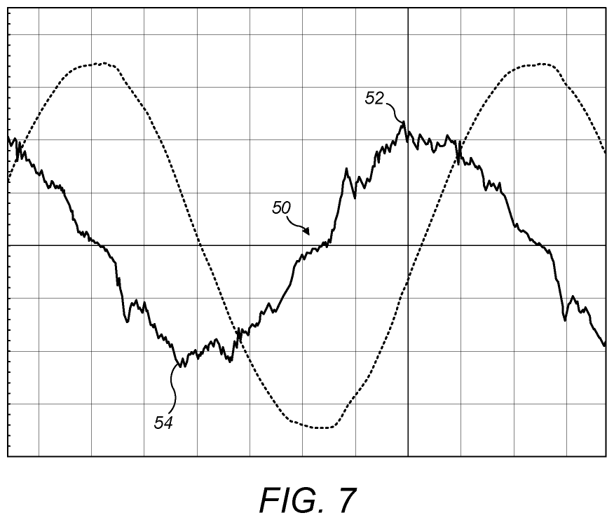

The user rotates the inserted aerosol generating article 100 through a full turn (360 degrees) at least once. During this initial calibration, the device 10 measures the impedance of the coil 36. Impedance may be measured incrementally (e.g. at discrete intervals that are sufficiently close together to obtain a substantially continuous impedance profile during the rotation) and/or continuously throughout the movement. This generates a measured impedance range 50 of the type shown in FIG. 7. The impedance range includes maximum 52 and minimum 54 measured values, which can then be stored in memory and used as control parameters/scalars as discussed above. e.g., min=60% power and max=100% power.

Thus, in the method described herein, the power delivery is either increased or decreased, depending on the measured operation impedance. The method described herein thus permits a user to have a physical control of the power delivery simply by moving (e.g. rotating) the aerosol generating article 100 inside the device to a selected position within the range of motion defined by the pre-defined motion. For example, where the pre-defined motion is a rotation of the aerosol generating article 100, such as a 360 degree rotation, the user may rotate the aerosol generating article 100 to a selected angular orientation in order to control the power that is delivered by aerosol generating device.

Use of the aerosol generating article 100 to set the power delivery has an intuitive feeling similar to that of a control knob, which can result in an improved user experience. A user may activate the intuitive power control method described herein by making a selection via the user interface, if present. Alternatively, a user may activate the power control method described herein by inserting an aerosol generating article 100 into the aerosol generating device 10 and moving the aerosol generating article 100 through the pre-defined motion.

As discussed above, the pre-defined motion may be a rotation, such as a rotation of greater than 180 degrees, greater than 270 degrees, or at least 360 degrees (or more). By rotating the aerosol generating article 100 through a full turn a full range of impedance values for that specific aerosol generating article 100 may be recorded. It will be appreciated, however, that other predefined motions are possible-for example a vertical movement within the heating chamber.

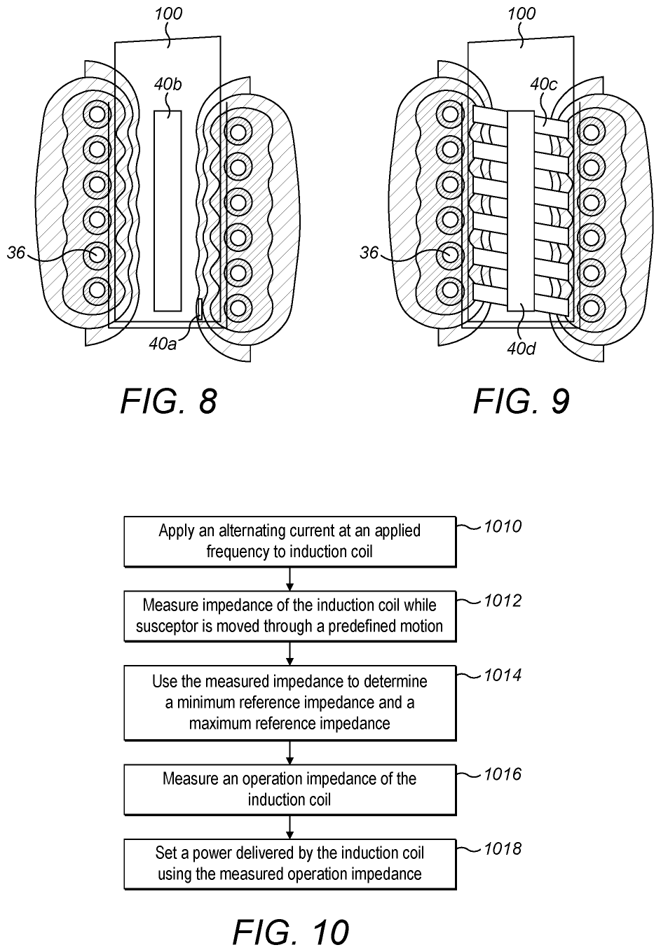

Different examples of an asymmetric susceptor 40 are shown in FIGS. 8 and 9.

FIG. 8 shows a secondary control susceptor 40a which is not aligned with the central axis of the tobacco stick, while a primary susceptor 40b is. The primary susceptor 40b is significantly larger than the secondary control susceptor 40a and is the main source of induction heating in the aerosol generating article. The secondary susceptor 40a has enough mass to influence the coil impedance and is preferably located near to, or on the surface of the aerosol generating article. In the example shown in FIG. 8, the secondary susceptor is located adjacent a location where the inductor coil ends, which increases the variation in the measured impedance range. The secondary susceptor may be made of the same or different material as the primary susceptor.

FIG. 9 shows a further example including a primary helical susceptor 40c, the asymmetry of which is increased by the addition of a secondary linear susceptor 40d. As in the case of the secondary control susceptor 40a shown in FIG. 8, the secondary linear susceptor 40d may be located nearer to the surface of the aerosol generating article than the primary susceptor 40c, for example at the surface, in order to further increase the asymmetry. The secondary susceptor may be made of the same or different material as the primary susceptor.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

1. A method of operating an aerosol generating device, the device comprising:
a heating chamber configured to receive an aerosol generating article; and
an induction heater comprising an induction coil operable configured to supply an alternating magnetic field to the heating chamber so as to induce eddy currents within a susceptor located in the heating chamber;
wherein the method comprises:
(a) applying an alternating current at an applied frequency to the induction coil;
(b) measuring a characteristic indicative of an impedance of the induction coil while the susceptor located in the heating chamber is moved through a pre-defined motion;
(c) determining a minimum reference impedance of the induction coil and a maximum reference impedance of the induction coil using the measured characteristic, wherein the minimum reference impedance is associated with a first position within the pre-defined motion and the maximum impedance is associated with a second position within the pre-defined motion;
(d) measuring a characteristic indicative of an operation impedance of the induction coil while the susceptor located in the heating chamber is maintained at a user-selected position within the pre-defined motion; and
(e) setting a power delivered by the induction coil using the operation impedance.

2. The method of claim 1, wherein the pre-defined motion is a rotation.

3. The method of claim 2, wherein the rotation is through 360 degrees or more.

4. The method of claim 1, wherein the susceptor is asymmetric under the pre-defined motion.

5. The method of claim 1, wherein the applied frequency is in the range 1-10 MHz.

6. The method of claim 1, further comprising providing an indication to a user indicative of the power set in step (e).

7. The method of claim 1, wherein setting a power delivered by the induction coil using the operation impedance comprises:
determining a scaling factor by comparing the operation impedance with one or both of the maximum and minimum reference impedances; and
scaling a power delivered by the induction coil using the determined scaling factor.

8. The method of claim 1, further comprising:
detecting insertion of the susceptor into the heating chamber;
detecting a movement of the susceptor through the pre-defined motion; and
automatically activating the method of steps (b)-(e).

9. The method of claim 1, wherein the characteristic indicative of impedance is measured continuously in step (b).

10. An aerosol generating device comprising:
a heating chamber configured to receive an aerosol generating article;
an induction heater comprising an induction coil configured to supply an alternating magnetic field to the heating chamber so as to induce eddy currents within a susceptor located in the heating chamber; and
a controller configured to carry out the method of claim 1 when the aerosol generating article comprising the susceptor is inserted into the heating chamber.

11. An aerosol generating system comprising:
an aerosol generating device in accordance with claim 10; and
an aerosol generating article comprising an asymmetric susceptor.

12. The aerosol generating system of claim 11, wherein the induction coil is a helical coil having a coil pitch (p1), and wherein the asymmetric susceptor comprises a helical susceptor having a susceptor pitch (p2), wherein the susceptor pitch is substantially the same as the coil pitch.

13. The aerosol generating system of claim 11, wherein the asymmetric susceptor comprises a first susceptor and a secondary susceptor, the secondary susceptor being smaller than the first susceptor such that a heating effect provided by the secondary susceptor is insignificant when compared with a heating effect provided by the primary susceptor.
